(19) United States
(12) Patent Application Publication
(10) Pub. No.: US 2007/0058843 A1
(43) Pub. Date: Mar. 15, 2007

(54) Secure Identification Device for Verifying Operator Identity

(76) Inventors: Jason Scott Theis, Manhattan Beach, CA (US); Robert Victor van Gils, Scottsdale, AZ (US)

Correspondence Address: ROBERT V VAN GILS, 6599 E THOMAS ROAD #102, SCOTTSDALE, AZ, 85251, US

(21) Appl. No.: 11/162,441

(22) Filed: Sep. 9, 2005

(51) Int. Cl. G06K 9/00

(52) U.S. Cl. 382/124; 340/5.52

(57) ABSTRACT

A fingerprint registration and verification device and system for a public amusement ride to prevent unauthorized persons from starting and operating the ride. The device can, with the addition of the required number of power relays, can be used on rides having any operating voltage. The device consists of a control panel, main board with memory which stores the enrolled fingerprints and the optional PIN number, and a finger switch contact. The fingerprint sensor scans and reads an input fingerprint, and sets and deletes a registered fingerprint. The control panel can also be used to input the optional PIN number. The main board stores the registered fingerprints and PIN number and compares the input fingerprint, or PIN number, with the registered fingerprints, or PIN number as applicable to send a signal to the finger switch contact and ride on button.

### TECHNICAL FIELD

The present invention relates to the field of identity verification, more specifically to a device and system for preventing unauthorized people from operating public amusement rides.

### BACKGROUND OF THE INVENTION

Currently operators of public amusement rides must be certified by the appropriate authorities to operate those rides. Rides are typically controlled by a conventional key which is used to switch the power to the ride on and off.

Any person who comes into possession of one of these keys is then able to operate the ride, whether they have the appropriate certification or not. The operation of a ride by a person who is not trained and certified in the operation of the ride can result in accidents causing death or serious injury.

The disadvantage of the current method is that keys can be lost or stolen and used by anyone who has the key in their possession and there is no way of knowing if the person who is using the key is a person who is certified and authorized to use the key. Another disadvantage is that a number of rides owned by an operator are frequently keyed alike. This means that a person, whether they are authorized or not, would be able to operate all rides which accept that key.

What is needed is a device and system to ensure that only those people who are certified, and authorized by the ride owner/operator, can operate the ride.

The present invention allows the ride owner/operator to easily enroll and delete the fingerprints of those people who are certified, and authorized by him/her, to operate the ride. In addition the owner/operator is able to set, and change, an optional PIN number for use when a user's enrolled fingerprint cannot be verified because of damage to the enrolled finger or damage to, or malfunction of, the fingerprint sensor.

### BRIEF DESCRIPTION OF THE DRAWINGS

FIG. 1 is a schematic view of the system installation according to the present invention.

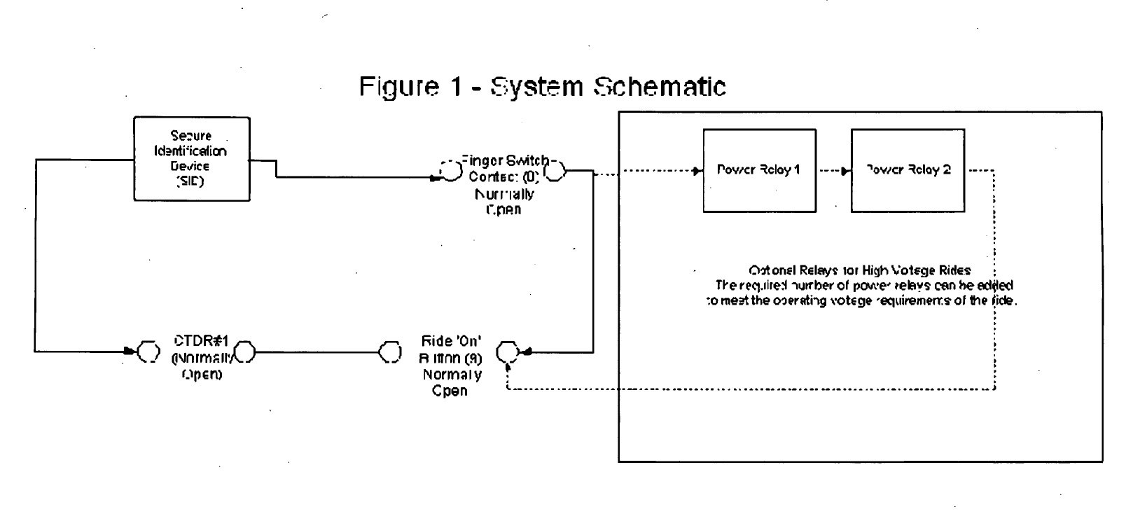

FIG. 2 is a front view of the system according to the present invention.

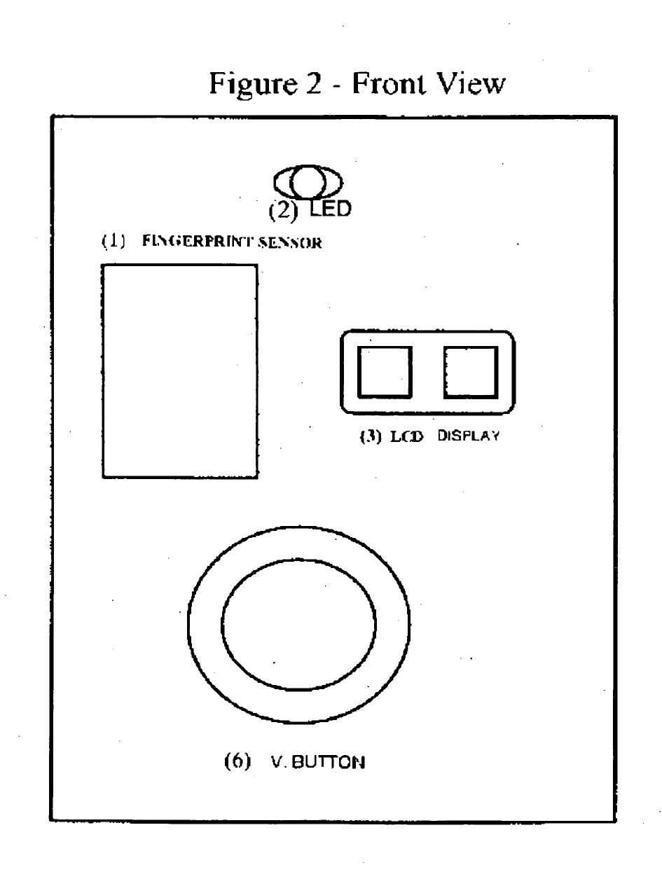

FIG. 3 is a side view of the system according to the present invention.

### DESCRIPTION OF THE PREFERRED EMBODIMENT

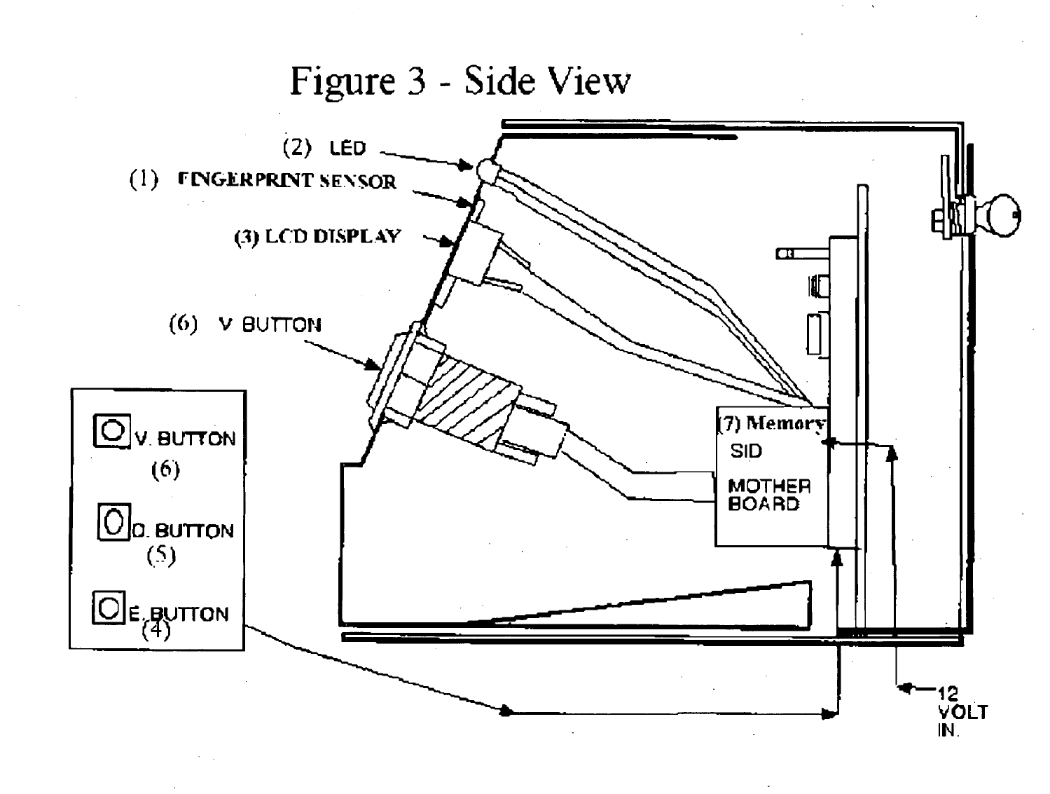

In the following description of the present invention the numbers correspond to the part numbers in FIG. 3. The abbreviations E, D & V are used to denote the Enroll button (4), Delete button (5) and Number Select button (6) respectively.

System Overview

In the present embodiment the invention prevents a public ride being started until an authorized user's credentials are verified by means of an enrolled fingerprint or an optional PIN number. The system can contain up to 21 fingerprint templates, 1 System Manager and up to 20 normal users, and one optional PIN number. While the number of fingerprints is currently set at 21 it is readily apparent to anyone skilled in the art that this number could be increased or decreased to suit different requirements.

The system contains a finger switch contact (8) which, in the non operating state, is in the open position. When the finger switch contact (8) is in the open position power is prevented from flowing to the ride on button (9) thus preventing the ride from being started.

To operate the system using a fingerprint, the user places their enrolled finger on the fingerprint sensor (1). The fingerprint is compared with the fingerprints stored in memory (7). If the fingerprint matches a fingerprint stored in memory (7) the Status LED (2) changes to green. Upon acceptance the finger switch contact (8) is closed to allow power to flow through to the ride on button (9) to allow the ride to be started and operated in the normal manner.

In the event that a user's enrolled finger has suffered damage, or the fingerprint sensor is damaged or malfunctioning, and they are not able to verify their fingerprint against those stored in memory (7) the authorized user can enter the optional PIN number to close the finger switch contact (8) to allow power to flow to the ride on button (9) to allow the ride to be started and operated in the normal manner.

In addition to the system allowing the finger switch contact (8) to be operated the system also automatically opens the finger switch contact (8) 30 seconds after the fingerprint has been verified, and no other actions take place, to prevent the public ride being operated until the enrolled fingerprint of an authorized user is verified against the fingerprint stored in memory, or the optional PIN number is entered.

The following paragraphs give a detailed description of the operation of the system including enrolling and deleting users fingerprints, enrolling the System Manager, starting and stopping the ride using a fingerprint or optional PIN number and setting and changing the optional PIN number.

Initial Enrolment

In the initial configuration there are no fingerprint templates stored in the memory (7) and the first user enrolled will be designated as the System Manager. Only the System Manager is able to enroll and delete users and set and change the PIN number for the device.

Powering Up for the First Time

When powering up, digits 00 will flash 3 times in the LCD (3) and then blink slowly. Only E button (4) can be activated to enroll the System Manager. The other two buttons are not operational at this stage.

Subsequently after user/s are being enrolled, if the system is powered up, the total number of users will be shown by blinking 3 times in the LCD (3) and subsequently, —(dash dash) will be displayed in the LCD (3) to indicate system is ready for use. The dual-color LED (2) will also blink 3 times in green.

Idle States the System has Two Idle States which are Described below:

State 1: —(dash dash) blinks slowly. The switch is currently open. Dual-color LED blinks at the same frequency in red too.
1. Press button V (6) toclose switch.
2. Press button D (5) to delete a user or all users.
3. Press button E (4) to enroll another user.

State 2: A number blinks slowly, if a user has closed the switch by verifying his finger, the number is his ID. CL blinks slowly in the LCD (3), if the user has closed the switch by entering a password. At the same time, the dual-color LED (2) will blink in green.
1. Press button V (6) to open switch.
2. Press button E (4) to enroll another user
   Enroll System Manager

This can only be done on a brand new system. System Manager will always be the first user to enroll and his ID will always be ‘01’

The procedure for enrolling the System Manager is as follows:
1. When 00 blinks slowly in the LCD (3), press E (4) button, EN will be shown in the LCD (3) and changes to PF which means place finger on sensor.
2. After fingerprint is placed on the sensor (1), rF, remove Finger, will be displayed in the LCD (3) to prompt the user to remove their finger from the sensor (1).
3. Once the enrollment is successful, user ID 01 will blink 3 times in the LCD (3) and the system will then enter Idle state 1.
4. If the enrollment fails, no will blink 3 times in the LCD (3) and then changes to slow blinking digits 00. System Manager to repeat Step 3 (Enroll System Manager).
5. In case error happened, Er or Ex(x=1,2 . . . ) will be shown in the LCD (3) and dual-color LED (2) changes to red. If the System Manager fails to put his finger on the sensor within 10 seconds, to (timeout) will blink in the LCD (3) a few times then change back to idle status.
   Enroll Normal User.

The System Manager must be present in order to enroll a user. Total number of users is 21, 1 System Manager and 20 normal users. Enrollment can be achieved either in Idle state 1 or in Idle state 2.

The procedure for enrolling a normal user is as follows:
1. Under either state, press button E (4) and EN will be shown in the LCD (3); when PF appears in the LCD (3), the System Manager places his finger on the sensor (1) for verification and when rF appears in the LCD (3), removes his finger from the sensor (1).
2. If the System Manager is successfully identified, System Manager's ID 01 will blink 3 times on the LCD (3).
3. When PF appears again in the LCD (3), new user may then place the enrolled finger on the sensor (1) and remove finger when rF is displayed in the LCD (3).
4. The user ID (which is automatically selected by the system) will blink 3 times, in the LCD (3), upon successful enrollment. The system will then return to the previous state of Idle State 1 or Idle State 2.
5. no will blink 3 times in the LCD (3) and return back to Idle state if the following occur:—
   a) Error occurs during System Manager Identification.
   b) Error occurs during user enrollment.
   c) When enrollment fails
   d) If fingerprint already exists in the system.

When the total number of users (including System Manager) reaches 21, FU will blink 3 times in the LCD (3). No user can be added into system under this condition unless users are deleted to free up the system.

The enrollment should be finished in 10 seconds, otherwise to (time out) will appear in the LCD (3).

Verification to Allow the Ride to be Started (Close Switch)

The system may be operated by one of two methods, firstly by verifying a users finger against the authorized fingerprints stored in memory (7) or by entering the system's PIN number.

Verifying by Fingerprint to Close Switch to Allow the Ride to be Started

To allow the ride to be started (close relay switch) the following procedure is used.

Under Idle state 1, press button V (6) and release, the display in the LCD (3) will change to UC.

There are 2 options:

Option 1:

1. Place finger on the sensor (1) and remove finger when rF appears in the LCD (3). The user's ID will blink fast 3 times in the LCD (3) and then blink slowly. This indicates that the user has successfully closed the switch and the system is now is Idle state 2 and the operator can start the ride using the ride on button.
2. If an error occurs during this step (due to incorrect fingerprint etc.), no will blink in the LCD (3) and the system will revert to Idle state 1.
   Option 2:
1. Press button V (6) or E (4) to select the desired user ID. V (6) denotes increasing number while E (4) denotes decreasing number. Numbers will automatically roll up or down when button V (6) or E (4) is held in for more than 2 seconds. When user ID is displayed in the LCD (3), the user places their enrolled finger on the sensor (1) and removes it when rF is displayed in the LCD (3).
2. When successful, the user ID will blink and the finger switch contact (8) is closed to allow power to flow through to the ride on button (9) to allow the ride to be started and operated in the normal manner. If an error occurs no will be displayed in the LCD (3).
   Close Switch (Allow the Ride to be Started) by Entering a Password.

The following procedure can be used to start the engine when an authorized user is unable to verify their fingerprint due to damage to the enrolled finger or a malfunction of, or damage to, the fingerprint sensor.
1. Press button V (6) and hold for more than 3 seconds until the display on LCD (3) changes to 1—(one dash) The left digit indicates the sequence number of digit of the password. The digit of the password entered will replace—(dash) on the left in the LCD (3).
2. Press button V (6) to scroll up 1,2,3 . . . ; Press button E (4) to scroll down 0,9,8 . . . ;
3. To select a digit, the button should be pressed within 1 second after the last button is pressed, otherwise the digit of the password will change to the next.
4. After a digit is selected, wait for more than 1 second, the right digit in the LCD (3) will change to next digit. If within 3 seconds there is no button pressed, a timeout will occur and be denoted by to being displayed in the LCD (3).
5. When all the four digits are entered, if they are right, oK will blink 3 times in the LCD (3) the display in the LCD (3) then changes to CL blinking slowly, and the dual-color status LED (2) blinks slowly in green. The finger switch contact (8) is closed to allow power to flow to the ride on button (9) to allow the ride to be started and operated in the normal manner
6. If the password is incorrect, no will blink 3 times, in the LCD (3), then the system will change back to idle state 1.
   Verification to Open Switch (Denotes Stops Ride)

The following procedures are used to open the relay switch. Opening the finger switch contact (8) causes power to stop flowing to the ride on button (9). With the finger switch contact (8) open the ride cannot be started again until the finger switch contact (8) is closed either by an authorized user verifying their enrolled fingerprint or entering the optional PIN number.
1. Press button V and hold it in for more than 3 seconds to open the finger switch contact (8). This will cause power to stop flowing to the ride on button (9).
2. If, after the finger switch contact (8) is closed and no other actions are performed within 30 seconds, the finger switch contact (8) will automatically open. This ensures that the fingerprint must be verified each time the ride is started or re-started and prevents an authorized user from giving control of the ride to an unauthorized user.
   Deleting a User or Users

Only the System Manager has the authority to delete users from the system. It is not necessary for the user being deleted to be physically present.

The following procedure is used by the System Manager to delete user(s) from the system.

In Idle state 1, press button D (5) and dL will appear in the LCD (3). Press button V (6) or E (4) to select the user ID to be deleted. Button V (6) denotes increasing number. Press and hold V (6) for more than 2 seconds and the ID number will roll up automatically. Button E (4) denotes decreasing number. Press and hold E (4) for more than 2 seconds and the ID number will roll down automatically. When the desired ID appears, the System Manager must place his enrolled finger on the sensor (1) and remove it when rF appears in the LCD (3).

oH will blink 3 times in the LCD (3) when the deletion process is successful.

If the ID selected is a normal ID number or is Code 22, system enters into Idle state 1.

If the ID selected is 23, 00 will blink slowly, representing a blank system that has no user enrolled.

The System Manager's ID number 01 will not appear in user deletion process. The System Manager's ID can only be deleted under 2 special ID codes.

Code 22 When User ID number 22 is selected, all the normal users will be deleted and only the System Manager's ID will remain in the system.

Code 23 When User ID number 23 is selected, all the users including the System Manager will be deleted and the system is reset to become a brand new system.

What is claimed is:

1. What is claimed is a device and system for preventing unauthorized personnel from operating public amusement rides by requiring verification of a user's identity, by comparing his fingerprint against fingerprints stored in the memory of the device or by entering a PIN and verifying it against the PIN number stored in the memory of the device, before allowing him/her to operate the ride. The device and systems is not a replacement for the normal on/off key but is designed to be used in conjunction with said on/off key.

2. A device and system having one user designated as the System Manager. The System Manager is the only user authorized to add and delete users fingerprints and to create and change the systems PIN number. One user is designated as the System Manager of the device and system in claim 1.

3. A device and system for storing a multiplicity of fingerprints of authorized ride operators in memory and comparing a presented fingerprint against the fingerprints stored in said memory, with a means for the System Manager to delete fingerprint(s) from the memory of the device without the user(s), whose fingerprints are being deleted, being physically present. One user is designated as the System Manager of the device and system in claim 1.

4. A device and system with a means for the System Manager to easily set, and change, an optional PIN number for use by authorized users whose fingerprint cannot be verified due to damage to the enrolled fingerprint or any other circumstance rendering fingerprint verification inoperable.

5. A device and system, as specified in claim 1, which automatically opens the finger switch contact (8) 30 seconds after the fingerprint or PIN is verified if no other actions are performed.
